(19) United States
(12) Patent Application Publication
(10) Pub. No.: US 2024/0362531 A1
(43) Pub. Date: Oct. 31, 2024

(54) INTELLIGENT SELF-ADJUSTING METRIC COLLECTION

(71) Applicant: NetApp, Inc., San Jose, CA (US)

(72) Inventors: Jeffrey Scott MacFarland, Wake Forest, NC (US); Brian Kevin Mah, Apex, NC (US); Jonathan Loring Price, Cary, NC (US)

(73) Assignee: NetApp, Inc., San Jose, CA (US)

(21) Appl. No.: 18/308,473

(22) Filed: Apr. 27, 2023

(51) Int. Cl. G06N 20/00

(52) U.S. Cl. CPC G06N 20/00

(57) ABSTRACT

Intelligent self-adjusting metric collection is described. A first rule set is distributed that describes a first set of one or more metrics corresponding to operation of elements of the receiving entities. One or more metrics based on the first rule set are received. A second rule set is generated in response to an indication of a condition change. The second rule set can be generated using machine learning techniques. The second rule set that describes a second set of one or more metrics is distributed. Metrics based on the second rule set are received.

### BACKGROUND

Computing systems collect data (e.g., logs, metrics) during normal operation that can be utilized for various purposes including, for example, error diagnosis, error recovery, performance evaluation, projection, etc. As systems become more complex and/or more distributed (e.g., distributed storage systems), data collection becomes more complex, which can result in various problem and deficiencies.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an example configuration of a plurality of nodes interconnected as a cluster.

FIG. 2 is a flow diagram of an example approach to provide intelligent self-adjusting metric collection.

FIG. 3 is an example of a system to provide intelligent self-adjusting metric collection.

FIG. 4 is a flow diagram of an example approach to provide intelligent self-adjusting metric collection.

FIG. 5 is an example of a system to provide intelligent self-adjusting metric collection.

### DETAILED DESCRIPTION

As discussed above, data collection techniques and mechanisms can become so complex that the data to be collected exceeds the capacities of the data collection infrastructure. As one example, a distributed data system management agent can include a component or layer of ONTAP® software available from NetApp, Inc. of Sunnyvale, CA. In the ONTAP example, a Counter Manager (CM) infrastructure can be used to gather, store and report performance metrics for various devices and subsystems based on values stored in counters (as well as other metrics). It is possible for the scope desired counter/data collection to exceed the capacities of the existing infrastructure. Other system software management components can be used for other applications and/or different types of environments (i.e., environments other than distributed storage systems).

Continuing with the CM/ONTAP example, the data collection mechanisms operation on the notion of objects, instances, and counters. An object defines a logical entity that can have one or more instances. For example, there may be a disk object where each instance of the object represents a disk in a node, and for each instance there exists a set of counters. Counters can correspond to, for example, reads, writes, throughput, etc. Thus, as the number of objects and/or instances grows, the data corresponding to the counters also grows. In some environments, the counter data is also transmitted to other system components, such as a management or error support entity.

Data collection related to counters and/or other metrics is typically accomplished by providing a rule set having a list of objects, counters, collection periods, etc. to be applied within the system to gather and store performance data. In some environments, data that has been collected is sent to a central repository for further analysis and/or storage. For example, data can be collected to report configurations, performance characteristics, subsystem status and/or exceptions in near real time to support diagnostic functionality. The amount of data that is collected to be transmitted may exceed the capacity of the designated infrastructure for handling collected data. That is, when utilizing inflexible data collection techniques, data may be lost or backlogged unless the underlying infrastructure is also expanded. This is a complex and difficult solution.

The mechanisms described herein improve on traditional data collection approaches by reducing the overall amount of data to be collected as well as reducing the overall amount of collected data that is transmitted over the collection infrastructure while ensuring that sufficient amounts of (and the correct type of) data are transmitted over the data collection infrastructure while ensuring that the desired functionality (e.g., support services, AI analysis) is supported. As described in the various examples below, machine learning (ML) enabled, dynamic rule set creation and distribution approaches are described. These approaches operate to predict that a problem might occur (e.g., a storage device may be failing, or a client workload may be increasing from a warning level toward a critical level), and subsequently apply a set of collection parameters that specify objects (e.g., disks) and counters (e.g., reads, writes, throughput, each for a corresponding disk) corresponding to the problem that might occur that would be valuable to capture at a higher frequency (e.g., as compared to baseline operation) for a specified duration of time (e.g., 25 seconds, 2 minutes). As another example, rather than a specified duration of time, the subsequent set of collection parameters can be applied until one or more specified conditions are detected. In an example, the specific objects, instances, and counters that belong to the subsequent set of collection parameters can be selected based on the conditions detected.

In general, machine learning techniques utilize algorithms to build models based on sampled data. The models can be used to make predictions or decisions based on the gathered data. Use of machine learning techniques in the context of collection and/or analysis of metrics in a particular environment (e.g., distributed storage system) can provide a tailored set of metrics (e.g., reads, capacity utilization) and frequency of collection (e.g., hourly, daily) to result in more optimal metric collection than using traditionally configured approaches.

The approaches described can provide several advantages under normal operating conditions. For example, some or all counters may be suspended (i.e., no data collected) during normal operation, which reduces bandwidth, storage and analytical resource consumption. In another example, a reduced set of counter data (with respect to common error conditions) can be collected during normal operation, which also reduces bandwidth, storage and analytical resource consumption. Thus, by selectively enabling counter data collection, system resources can be more efficiently utilized, finer granularity and/or other advantageous conditions can be provided.

In an example, the conditions that define when counter collection should be triggered, the counter information to collect, the frequency of collection, the duration of the collection and/or other relevant collection parameters can be defined by one or more rules. Rules can vary in complexity from, for example, a trigger based on a threshold being crossed (e.g., subsystem up to subsystem down) to more complex rules that use forecasting and machine learning (ML) models to predict future events. Several example rules and corresponding collection are described in greater detail below.

In an example, rules can be dynamically added, modified or removed on, for example, storage systems through the collection infrastructure. Similar dynamic use of rules and use of a collection infrastructure can be utilized in different environments (i.e., other than distributed storage systems). Thus, new rules can be generated and deployed in a timely fashion to handle critical field issues.

As a specific example, collection of file system and protocol counters can be triggered when a client is experiencing a latency issue when accessing a specific storage device in a distributed storage system. In this example, the relevant rule(s) may forecast the latency of one or more clients that have reached a warning threshold and when the client workload may cross from a warning level to a critical level, and collect additional counters before, after and during the critical latency condition.

In a distributed storage system environment, allowing storage controllers (i.e., edge devices) to take an active role in the intelligent triggering, collection, and retrieval of data as well as participating in distributed machine learning provides greater efficiencies and flexibility with the host environment. Similar advantages can be achieved in other environments.

In some environments, payloads utilized to collect and transport collected data can be limited or fixed in size. Thus, excessive collection of data can flood the transport infrastructure. By providing a reduced, and dynamically configured, collection of data, the transport infrastructure can be more efficiently utilized, which can provide performance improvements. Further, by providing a reduced, and dynamically configured, collection of data, analytics resources and customer support resources can be more efficiently utilized.

Various embodiments of the present technology provide for a wide range of technical effects, advantages, and/or improvements to computing systems and components. For example, various embodiments may include one or more of the following technical effects, advantages, and/or improvements: 1) non-routine and unconventional approaches to determining and distributing rule sets to be used in gathering and/or analyzing metrics associated with system components; 2) non-routine and unconventional use of machine learning techniques to provide more optimal collection, transmission, analysis and/or storage of metrics associated with system components; 3) dynamic configuration/adjustment of metric collection transport parameters to utilize allocated bandwidth intelligently and efficiently; and/or 4) non-routine and unconventional approaches to use of edge device performance data to influence subsequent edge device performance data collection utilizing machine learning techniques.

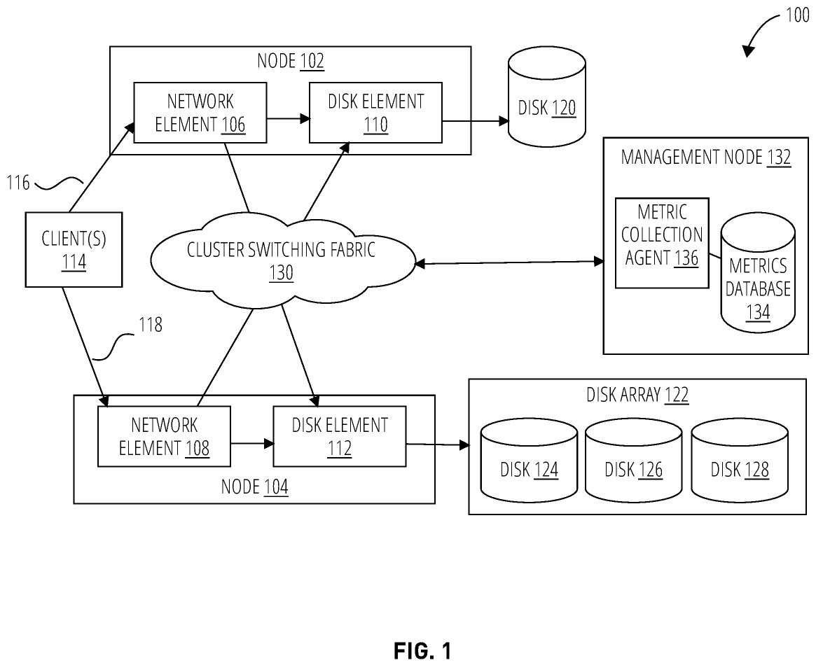

FIG. 1 is a block diagram of an example configuration of a plurality of nodes interconnected as a cluster. The cluster of nodes illustrated in FIG. 1 can be configured to provide storage services relating to the organization of information on storage devices. Further, the cluster of nodes illustrated in FIG. 1 can be managed utilizing the intelligent self-adjusting metric collection mechanisms described herein. While the cluster of FIG. 1 is illustrated with two nodes, any number of nodes can be included in a cluster.

The nodes of FIG. 1 (e.g., node 102, node 104) include various functional components that cooperate to provide a distributed storage system architecture of cluster 100. To that end, each node is generally organized as a network element (e.g., network element 106 in node 102, network element 108 in node 104) and a disk element (e.g., disk element 110 in node 102, disk element 112 in node 104). The network elements provide functionality that enables the nodes to connect to client(s) 114 over one or more network connections (e.g., 116, 118), while each disk element connects to one or more storage devices (e.g., disk 120, disk array 122). Counters and/or other metric collection mechanisms can be included within one or more of network element 106, network element 108, disk element 110, disk element 112, disk 120, disk 124, disk 126, disk 128.

Counters, for example, can be used to provide a statistical measurement of activity on a storage object or storage subsystem. These statistical measurements can be used to provide insight into system health, utilization, trends, and the like. While not shown in FIG. 1, visualization tools can be used to help present and interpret the collected data. For example, a volume's total_ops counter can be used to track the total operations per second on that volume.

In the example of FIG. 1, disk element 110 connects to disk 120 and disk element 112 connects to disk array 122 (which includes disk 124, disk 126 and disk 128). Node 102 and node 104 are interconnected by cluster switching fabric 130 which, in an example, may be a Gigabit Ethernet switch. It should be noted that while there is shown an equal number of network and disk elements in cluster 100, there may be differing numbers of network and/or disk elements. For example, there may be a plurality of network elements and/or disk elements interconnected in a cluster configuration that does not reflect a one-to-one correspondence between the network and disk elements. As such, the description of a node comprising one network elements and one disk element should be taken as illustrative only.

Management node 132 is connected with node 102 and node 104 by cluster switching fabric 130 to provide various management operations. In an example, management node 132 collects metrics associated with nodes, components of nodes, disks, etc. In an example, collection of metrics is dynamically managed by metric collection agent 136. As described in greater detail below, machine learning techniques can be used in the dynamic management of metric collection. The collected metrics and information can be used for various management operations including, for example, error detection and recovery. In an example, collected metrics and information can include counters (as discussed above), system log files, configuration data (e.g., formatted as an XML file, unstructured data), state data (e.g., subsystem up/down, capacity used), performance metrics, system inventory data, latency, request size, read counters, write counters, etc. In an example, the metrics that are collected support a broad range of conditions including, but not limited to, performance, stability, capacity, security vulnerabilities, misconfigurations, failing hardware, conditions that cause performance degradation, outdated components, software and/or firmware, for example. In an example, at least a portion of the metrics that are collected are stored on metrics database 134. The stored data can be used, for example, for diagnostic and/or troubleshooting purposes. In an example, metric collection agent 136 can manage and distribute rule sets to be used in metric collection.

As discussed above, payloads utilized to transport collected data over cluster switching fabric 130 can be limited or fixed in size. By providing a reduced, and dynamically configured, collection of data as controlled by metric collection agent 136, the finite capacities of the transport infrastructure can be more efficiently utilized, which can provide performance improvements. Further, by providing a reduced, and dynamically configured, collection of data, analytics resources and customer support resources including, for example, metrics database 134, can be more efficiently utilized.

Client(s) 114 may be general-purpose computers configured to interact with node 102 and node 104 in accordance with a client/server model of information delivery. That is, each client may request the services of a node, and the corresponding node may return the results of the services requested by the client by exchanging packets over one or more network connections (e.g., 116, 118).

Client(s) 114 may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks.

Disk elements (e.g., disk element 110, disk element 112) are illustratively connected to disks that may be individual disks (e.g., disk 120) or organized into disk arrays (e.g., disk array 122). Alternatively, storage devices other than disks may be utilized, e.g., flash memory, optical storage, solid state devices, etc. As such, the description of disks should be taken as exemplary only. A file system may implement a plurality of flexible volumes on the disks. Flexible volumes may comprise a plurality of directories and subdirectories.

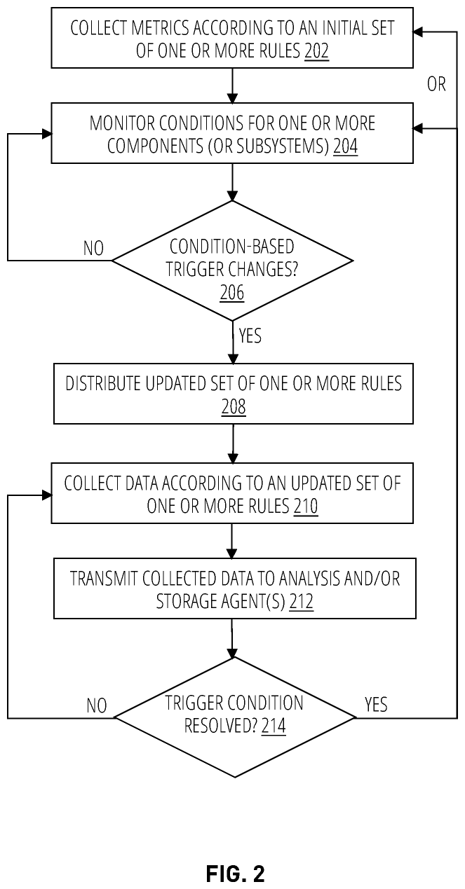

FIG. 2 is a flow diagram of an example approach to provide intelligent self-adjusting metric collection. The metric collection techniques as described with respect to FIG. 2 can be used to collect metrics in a cluster environment as illustrated in FIG. 1. In an example, the approach as illustrated in FIG. 2 can be under the control of metric collection agent 136. In other example configurations, one or more other components can provide the described functionality.

In an example, the initial rule set indicating metrics to be collected can be used to predict a problem before it occurs and then the subsequent rule set indicating metrics to be collected is tailored to the predicted problem. For example, one or more of the initial set of metrics can indicate a component reaching performance or capacity limits due to growth (e.g., based on a write counter) or compromised security (e.g., based on a read counter).

For example, the subsequent rule set metrics may be different than the initial metrics and/or the frequency of collection for one or more metrics may be increased in response to the predicted problem. For example, as a storage device approaches a capacity limit, the frequency of transmission (e.g., from the storage device to the metric collection agent) of the counter value can be increased so that the management node has more current information. As another example, subsystem up/down status indicator may be transmitted to the management node more frequently to support evaluation of whether the subsystem is temporarily unavailable or if the subsystem has failed.

By enabling (or increasing the frequency of collection for) one or more “expensive-to-store” metrics (e.g., counters) dynamically and for a limited time, increased granularity can be provided without overwhelming the metric collection infrastructure.

In an example, metrics are collected according to an initial set of one or more rules, 202. The rules are intended to provide an explicit set of regulations, commands, and/or objectives to govern the conduct of the metric collection. As a simple example, a set of read and write counters and configuration data for a storage device can be transmitted to a management node once a day. As another example, a system log file can be transmitted once a week at a specified time (e.g., a known low bandwidth utilization time) to the management node.

Various approaches can be utilized to select the initial set of rules for collecting metrics. For example, a first set of rules can be used for storage devices that are part of a node in a distributed storage system. Another set of rules can be used for storage devices that are part of a RAID system in a node of the distributed storage system. Both of these rule sets can cause the collected metrics to be reported to the same management node in the distributed storage system over a commonly shared infrastructure. In an example, under initial operational conditions, a minimal set of counters (e.g., reads, writes, throughput) can be maintained, and the values corresponding to the counters can be periodically transmitted to the management node and/or stored. Subsequently, an expanded set of counters (e.g., reads, writes, throughput, latency, instances, connections) can be maintained and the values corresponding to the expanded set of counter can be periodically transmitted to the management node and/or stored.

The metrics collected using the initial set of rules are used to monitor conditions for one or more components (or subsystems) in the environment, 204. In an example, the rule sets for various components or subsystems can be independent of each other. That is, the initial rule set for a storage device and subsequent rule sets used with that storage device can be independent of any rule set for a different storage device. In an example, the conditions to be monitored can be dynamically selected based on one or more machine learning techniques. For example, machine learning techniques can be utilized to determine the most likely problematic conditions (e.g., component failure, overuse, underuse, misconfiguration) for a specific component or subsystem and the corresponding metrics used to create the initial rule set(s). Alternatively, default rule sets based on heuristics can be utilized.

If the conditions as indicated by the collected metrics do not correspond to conditions for a rule set change, 206, collection of metrics continues using the initial set of rules, 204. Conditions to trigger a rule set change can be any set of metrics that indicate, for example, a negative change in operating conditions are likely or possibly starting (e.g., nearing storage capacity, increasing latency). Other conditions can also be used to trigger a rule set change, for example, indications of system configuration changes, passage of a specified period of time,

If the conditions as indicated by the collected metrics do correspond to conditions for a rule set change, 206, a new set of rules is distributed, 208. In an example, the new set of rules is based on the condition detected (e.g., in 206). Further, the new set of rules can be developed and/or selected based on one or more machine learning techniques. Thus, many sets of rules can be maintained and deployed in response to the type of condition detected (e.g., 206). Also, rule sets to be deployed can evolve over time using machine learning techniques to adapt the rule sets to observed conditions. In some examples, multiple sets of updated rule sets can be applied concurrently.

Data is collected according to the updated set of one or more rules, 210. As the data is collected, the data is transmitted to an analysis agent and/or to a storage agent, 212. As mentioned above, the frequency of data collection can be increased or decreased based on the rule set(s) being utilized. Thus, the amount of data transferred utilizing limited system resources can be dynamically tailored to fit the monitored conditions.

In an example, if the trigger condition has not been resolved, decision block 214, data collection continues, 210. If the condition has been resolved, decision block 214, conditions can be monitored for subsequent conditions. In an example, the rule set can revert to the initial rule set, 202. In another example, a new, subsequent rule set can be distributed an applied if the trigger condition has not been resolved, for example, if a secondary condition is detected or if a new set of conditions is detected, or if a specified period of time has elapsed. Various combinations can also be used to determine what rule sets to use. Further, subsequent rule sets are not necessarily replacements for previous rule sets. That is, each rule set can have a different number of corresponding metrics, collection frequencies, transmission (e.g., to the management node) frequencies, storage frequencies, or any combination thereof.

Machine learning techniques and/or predictive analytics techniques can be utilized to monitor collected metrics to identify risk factors and or undesirable conditions related to, for example, system health, system availability, security, performance, storage utilization, bandwidth utilization, etc. Metrics and/or related information (e.g., network topology, geographic location information) from any number of system components/entities can be analyzed to improve rule sets and corresponding metrics, collection frequencies and/or transmission frequencies to be used according to the approaches described herein.

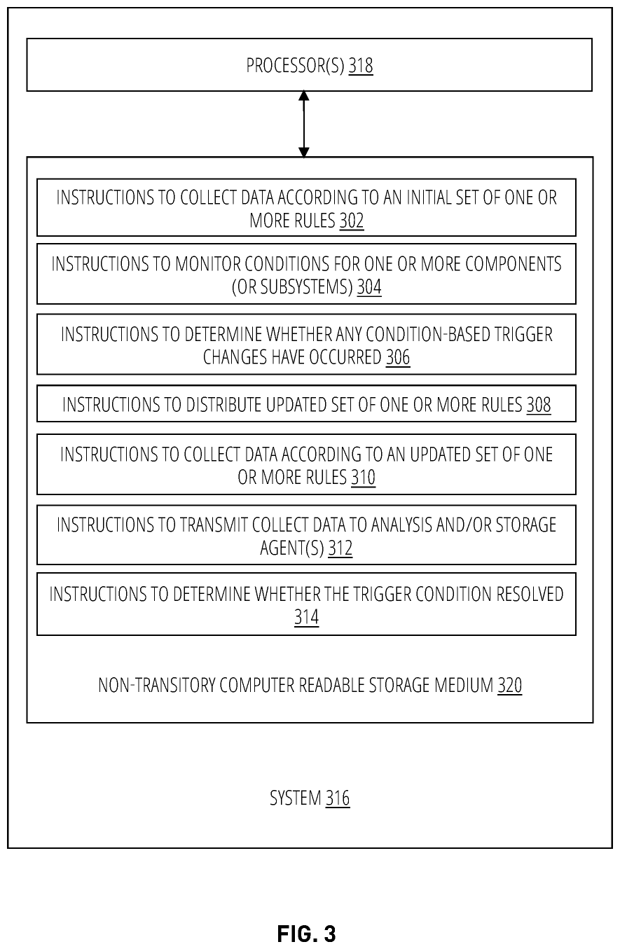

FIG. 3 is an example of a system to provide intelligent self-adjusting metric collection. In an example, system 316 can include processor(s) 318 and non-transitory computer readable storage medium 320. In an example, processor(s) 318 and non-transitory computer readable storage medium 320 can be part of a management node (e.g., management node 132) having a storage operating system that can provide some or all of the functionality of the ONTAP software as mentioned above. In an example, system 316 can provide the functionality described herein with respect to metric collection (e.g., metric collection agent 136).

Non-transitory computer readable storage medium 320 may store instructions 302, 304, 306, 310, 312 and 314 that, when executed by processor(s) 318, cause processor(s) 318 to perform various functions. Examples of processor(s) 318 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer readable storage medium 320 include tangible media such as random-access memory (RAM), read-only memory (ROM), electrically erasable programmable read-only memory (EEPROM), flash memory, a hard disk drive, etc.

In response to execution of instructions 302, processor(s) 318 cause metrics to be collected according to an initial set of one or more rules. Various approaches can be utilized to select the initial set of rules for collecting metrics. In an example, a minimal set of counters (e.g., reads, writes, throughput) can be maintained, and the values corresponding to the counters can be periodically collected. In another example, an expanded set of counters (e.g., reads, writes, throughput, latency, instances, connections). For example, one or more of the initial set of metrics can indicate a component reaching performance limits (e.g., based on observed latency or system log information) or consuming excess bandwidth (e.g., based on a transmission counter).

In response to execution of instructions 304, processor(s) 318 cause the metrics collected using the initial set of rules to be used to monitor conditions for one or more components (or subsystems) in the environment. Various metric collection mechanisms can be utilized including, for example, one or more counters, etc. In an example, one or more of the initial set of metrics can indicate a component reaching performance or capacity limits due to growth (e.g., based on a write counter) or compromised security (e.g., based on a read counter).

In response to execution of instructions 306, processor(s) 318 can determine whether any condition-based trigger changes have occurred. If the conditions as indicated by the collected metrics do not correspond to conditions for a rule change, collection of metrics continues using the initial set of rules, (e.g., instructions 304). For example, as a storage device approaches a capacity limit, the frequency of transmission (e.g., from the storage device to the metric collection agent) of the counter value can be increased so that the management node has more current information. As another example, subsystem up/down status indicator may be transmitted to the management node more frequently to support evaluation of whether the subsystem is temporarily unavailable or if the subsystem has failed.

If the conditions as indicated by the collected metrics do correspond to conditions for a rule change, instructions 308 cause processor(s) 318 to distribute a new set of rules. In an example, the new set of rules is based on the condition detected (e.g., by instructions 306). Thus, many sets of rules can be maintained and deployed in response to the type of condition detected (e.g., by instructions 306). In other examples, new sets of rules can be distributed based on conditions from any number of components and/or subsystems and the various sets of rules can be deployed independently of each other. In some examples, multiple sets of updated rule sets can be applied concurrently and/or independently.

In response to execution of instructions 310, processor(s) 318 can cause collection of data according to the updated set of one or more rules. As the data is collected, the data is transmitted to an analysis agent and/or to a storage agent in response to instructions 312 being executed by processor(s) 318. As mentioned above, the frequency of data collection can be increased or decreased based on the rule set(s) being utilized. Thus, the amount of data transferred utilizing limited system resources can be dynamically tailored to fit the monitored conditions.

In an example, machine learning techniques can be utilized to identify problematic conditions (e.g., component failure, overuse, underuse, misconfiguration) for a specific component or subsystem and the corresponding metrics used to create the rule set(s) to be used with the components or subsystems. In an example, one or more rule sets can be based on heuristics can also be used concurrently with one or more rule sets that are developed using machine learning techniques.

In an example, in response to execution of instructions 314, processor(s) 318 can cause a component to determine if the trigger condition has been resolved. If the trigger condition has not been resolved (e.g., instructions 306), data collection continues (e.g., instructions 310). If the condition has been resolved (e.g., instructions 306), conditions can be monitored for subsequent conditions (e.g., instructions 304). In an example, the rule set can revert to the initial rule set (e.g., instructions 302). In another example, a new, subsequent rule set can be distributed an applied if the trigger condition has not been resolved, for example, if a secondary condition is detected or if a new set of conditions is detected, or if a specified period of time has elapsed. Various combinations can also be used to determine what rule sets to use. Further, subsequent rule sets are not necessarily replacements for previous rule sets. Thus, each rule set can have a different number of corresponding metrics, collection frequencies, transmission (e.g., to the management node) frequencies, storage frequencies, or any combination thereof.

Machine learning techniques and/or predictive analytics techniques can be utilized to monitor collected metrics to identify risk factors and or undesirable conditions related to, for example, system health, system availability, security, performance, storage utilization, bandwidth utilization, etc. Metrics and/or related information (e.g., network topology, geographic location information) from any number of system components/entities can be analyzed to improve rule sets and corresponding metrics, collection frequencies and/or transmission frequencies to be used according to the approaches described herein.

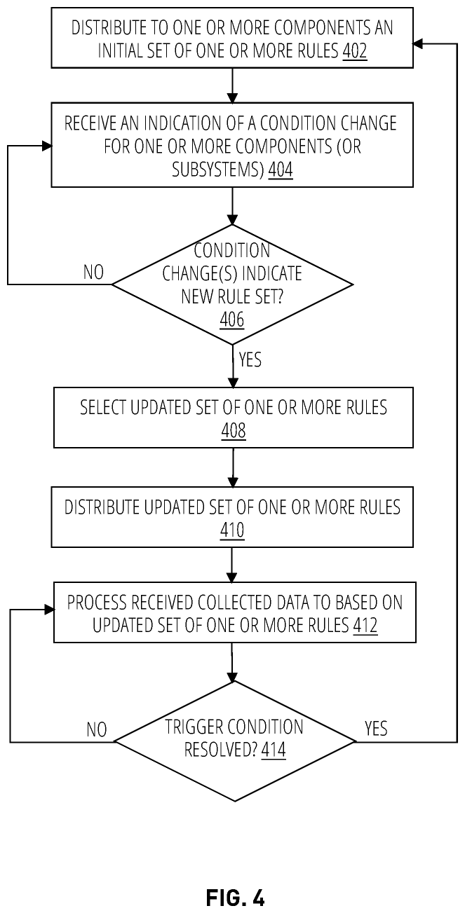

FIG. 4 is a flow diagram of an example approach to provide intelligent self-adjusting metric collection. The metric collection techniques as described with respect to FIG. 4 can be used to collect metrics in a cluster environment as illustrated in FIG. 1. In an example, the approach as illustrated in FIG. 4 can be under the control of metric collection agent 136. In other example configurations, one or more other components can provide the described functionality.

As discussed above, the initial set of metrics collected, and from that information analytics tools including machine learning can be utilized to monitor conditions within the operating environment and subsequent rule sets to cause different sets of metrics to be collected based on monitored conditions. In an example, metrics are collected according to an initial set of one or more rules that have been distributed, 402. In an example, a minimal set of counters (e.g., reads, writes, throughput) can be maintained, and the values corresponding to the counters can be periodically collected. Use of a minimal set of counters can be beneficial in consuming a minimal amount of infrastructure bandwidth when operating conditions are satisfactory. In another example, an expanded set of counters (e.g., reads, writes, throughput, latency, instances, connections) can be used to collect more detailed information about various components of the environment being monitored.

The metrics collected using the initial set of rules are used to monitor conditions for one or more components (or subsystems) in the environment. Based on the collected metrics, an indication of a condition change for one or more components (or subsystems) is received, 404. In an example, the conditions to be monitored and/or the subsequent rule sets can be dynamically selected based on one or more machine learning techniques. If the conditions as indicated by the collected metrics do not correspond to conditions for a rule change (as determined by machine learning outputs and/or other factors), 406, collection of metrics continues using the initial set of rules, 404.

If the conditions as indicated by the collected metrics do correspond to conditions for a rule change, 406, a new set of rules is selected, 408. In an example, the new set of rules is based on the condition detected (e.g., in 406), but other factors including, for example, passage of a specified period of time and/or other conditions can also be used. Further, the new set of rules can be developed and/or selected based on one or more machine learning techniques. Thus, many sets of rules can be maintained and deployed in response to the type of condition detected (e.g., 406). For example, as a storage device passes a specified capacity value, one or more counters corresponding to the capacity utilization of the storage device can be increased (e.g., more frequent updates, more frequent reports, more frequent analysis) to more closely monitor the utilization of the storage device and potentially avoid a situation where the storage device is overutilized or underutilized. In some examples, multiple sets of updated rule sets can be applied concurrently.

The updated set of rules is distributed, 410. After the data is collected, the data is transmitted to an analysis agent and/or to a storage agent. As mentioned above, the frequency of data collection can be increased or decreased based on the rule set(s) being utilized. Thus, the amount of data transferred utilizing limited system resources can be dynamically tailored to fit the monitored conditions.

Data that has been received as a result of data collection based on the updated set of rules is processed, 412. Various levels of data processing can be provided including, for example, the data can be stored for later analysis, a preliminary high-level analysis can be performed, a low-level error recovery analysis can be performed, etc.

If the trigger condition has not been resolved, decision block 414, data collection continues, 410. If the condition has been resolved, decision block 414, conditions can be monitored for subsequent conditions. In an example, the rule set can revert to the initial rule set, 402. In another example, a new, subsequent rule set can be distributed an applied if the trigger condition has not been resolved, for example, if a secondary condition is detected or if a new set of conditions is detected, or if a specified period of time has elapsed. Various combinations can also be used to determine what rule sets to use. Further, subsequent rule sets are not necessarily replacements for previous rule sets. In an example, each rule set can have a different number of corresponding metrics, collection frequencies, transmission (e.g., to the management node) frequencies, storage frequencies, or any combination thereof.

Machine learning techniques and/or predictive analytics techniques can be utilized to monitor collected metrics to identify risk factors and or undesirable conditions related to, for example, system health, system availability, security, performance, storage utilization, bandwidth utilization, etc. Metrics and/or related information (e.g., network topology, geographic location information) from any number of system components/entities can be analyzed to improve rule sets and corresponding metrics, collection frequencies and/or transmission frequencies to be used according to the approaches described herein.

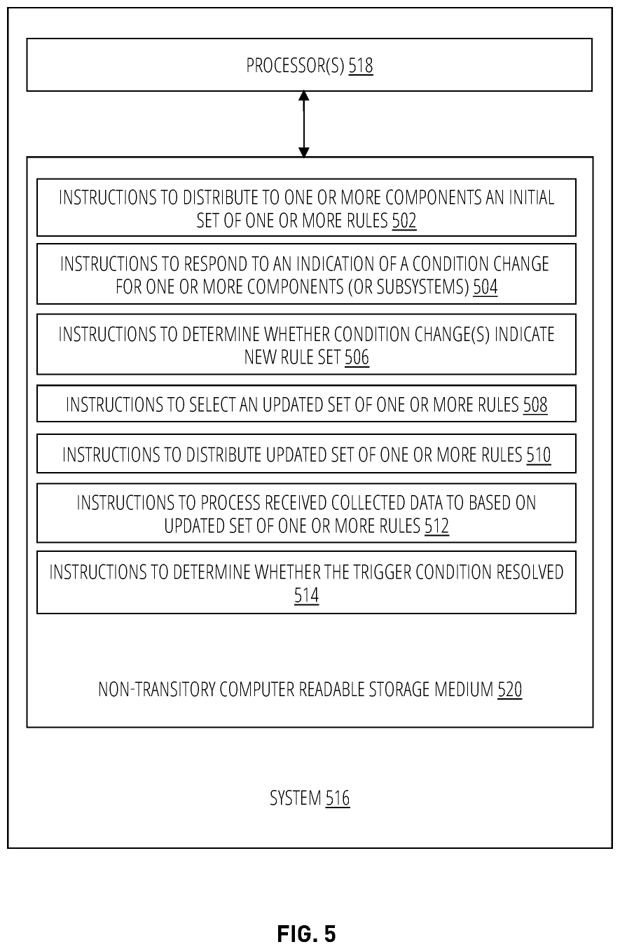

FIG. 5 is an example of a system to provide intelligent self-adjusting metric collection. In an example, system 516 can include processor(s) 518 and non-transitory computer readable storage medium 520. In an example, processor(s) 518 and non-transitory computer readable storage medium 520 can be part of a management node (e.g., management node 132) having a storage operating system that can provide some or all of the functionality of the ONTAP software as mentioned above. In an example, system 516 can provide the functionality described herein with respect to metric collection (e.g., metric collection agent 136).

Non-transitory computer readable storage medium 520 may store instructions 502, 504, 506, 510, 512 and 514 that, when executed by processor(s) 518, cause processor(s) 518 to perform various functions. Examples of processor(s) 518 may include a microcontroller, a microcontroller, a microprocessor, a CPU, a GPU, a DPU, an ASIC, a FPGA, a system on a chip (SoC), etc. Examples of non-transitory computer readable storage medium 520 include tangible media such as RAM, ROM, EEPROM, flash memory, a hard disk drive, etc.

Instructions 502 cause processor(s) 518 to distribute an initial set of one or more rules. These rules are used by the receiving entities to collect data. Various approaches can be utilized to select the initial set of rules for collecting metrics. In an example, a minimal set of counters (e.g., reads, writes, throughput) can be maintained, and the values corresponding to the counters can be periodically collected. In another example, an expanded set of counters (e.g., reads, writes, throughput, latency, instances, connections) can be used to collect more detailed information about various components of the environment being monitored.

In response to execution of instructions 504, processor(s) 518 cause the metrics collected using the initial set of rules to be used to monitor conditions for one or more components (or subsystems) in the environment. Based on the collected metrics, an indication of a condition change for one or more components (or subsystems) is received. In an example, the conditions to be monitored and/or the subsequent rule sets can be dynamically selected based on one or more machine learning techniques. If the conditions as indicated by the collected metrics do not correspond to conditions for a rule change (as determined by machine learning outputs and/or other factors)

In response to execution of instructions 506, processor(s) 518 can determine whether any monitored conditions have changed, and those changes indicate a new rule set is appropriate. If the conditions as indicated by the collected metrics do not correspond to conditions for a rule change, collection of metrics continues using the initial set of rules, (e.g., instructions 504).

If the conditions as indicated by the collected metrics do correspond to conditions for a rule change, instructions 508 cause processor(s) 518 to select a new set of rules. In an example, the new set of rules is based on the condition detected (e.g., by instructions 506), but other factors including, for example, passage of a specified period of time and/or other conditions can also be used. Thus, many sets of rules can be maintained and deployed in response to the type of condition detected (e.g., by instructions 506). For example, as a storage device passes a specified rate of write failures, this may indicate that the storage device is failing and one or more counters can be increased (e.g., more frequent updates, more frequent reports, more frequent analysis) to more closely monitor the condition of the storage device and potentially avoid a situation where the storage device fails and data may be lost. In some examples, multiple sets of updated rule sets can be applied concurrently.

In response to execution of instructions 510, processor(s) 518 causes the updated rule set(s) to be distributed to components within the host system. The updated rule set(s) can be distributed to the same set of one or more components (or subsystems) in the environment as the initial rule set, or the updated rule set(s) can be distributed to a different set of one or more components (or subsystems) within the environment.

Instructions 512 cause processor(s) 518 to process data collected according to the updated set of one or more rules. As the data is collected, the data is transmitted to an analysis agent (e.g., metric collection agent 136) and/or to a storage agent (e.g., metrics database 134) in response to instructions 514 being executed by processor(s) 518. As mentioned above, the frequency of data collection can be increased or decreased based on the rule set(s) being utilized. Thus, the amount of data transferred utilizing limited system resources can be dynamically tailored to fit the monitored conditions.

If the trigger condition has not been resolved (e.g., instructions 514), data collection and processing continue (e.g., instructions 512). If the condition has been resolved (e.g., instructions 514), conditions can be monitored for subsequent conditions. In an example, the rule set can revert to the initial rule set (e.g., instructions 502). In another example, a new, subsequent rule set can be distributed an applied if the trigger condition has not been resolved, for example, if a secondary condition is detected or if a new set of conditions is detected, or if a specified period of time has elapsed. Various combinations can also be used to determine what rule sets to use. Further, subsequent rule sets are not necessarily replacements for previous rule sets. In an example, each rule set can have a different number of corresponding metrics, collection frequencies, transmission (e.g., to the management node) frequencies, storage frequencies, or any combination thereof.

Machine learning techniques and/or predictive analytics techniques can be utilized to monitor collected metrics to identify risk factors and or undesirable conditions related to, for example, system health, system availability, security, performance, storage utilization, bandwidth utilization, etc. Metrics and/or related information (e.g., network topology, geographic location information) from any number of system components/entities can be analyzed to improve rule sets and corresponding metrics, collection frequencies and/or transmission frequencies to be used according to the approaches described herein.

Example embodiments presented above may be implemented as any or a combination of one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an example” means that a particular feature, structure, or characteristic described in connection with the example embodiment is included in at least one embodiment of the disclosure. The appearances of the phrase “in one embodiment” or “in an example” in various places in the specification are not necessarily all referring to the same example embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component”, “module”, “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

What is claimed is:

1. A management node in a distributed storage system, the management node comprising:
a memory system; and
one or more processors coupled with the memory system, the one or more processors to:
distribute a first rule set that indicates to receiving entities within the distributed storage system a first set of one or more metrics corresponding to operation of elements of the receiving entities,
receive metric data from the receiving entities based on the first rule set,
distribute a second rule set in response to the received metric data, wherein the second rule set indicates to receiving entities within the distributed storage system a second set of one or more metrics corresponding to operation of elements of the receiving entities, and wherein the metrics of the second rule set are determined utilizing machine learning techniques and based received metric data corresponding to the first rule set, and
receive metric data from the receiving entities based on the second rule set.

2. The management node of claim 1, further comprising performing operational analysis on the received metric data corresponding to the first rule set to predict diminished performance of at least one of the receiving entities.

3. The management node of claim 1, wherein the first rule set has a first set of reporting frequencies for metric data collected according to the first rule set and the second rule set has a second set of reporting frequencies for metric data collected according to the second rule set.

4. The management node of claim 1, wherein the first rule set has a first set of collection frequencies for metric data collected according to the first rule set and the second rule set has a second set of collection frequencies for metric data collected according to the second rule set.

5. The management node of claim 1, wherein the first rule set results is collection of metric data from a first number of receiving entities and the second rule set results in collection of metric data from a second number of receiving entities.

6. The management node of claim 1, wherein the one or more processors are further configured to distribute a third rule set in response to the received metric data, wherein the third rule set indicates to receiving entities within the distributed storage system a third set of one or more metrics corresponding to operation of elements of the receiving entities, and wherein the metrics of the third rule set are determined utilizing machine learning techniques and based received metric data corresponding to the first rule set and received metric data corresponding to the second rule set.

7. A non-transitory computer readable storage medium having stored thereon instructions that, when executed by one or more processors, cause the one or more processors to:
distribute to receiving entities within the distributed storage system an indication of a first set of one or more metrics corresponding to operation of elements of the receiving entities;
receive metric data from the receiving entities based on the first set of one or more metrics;
generate, dynamically with machine learning techniques, an indication of a second set of one or more metrics corresponding to operation of elements of the receiving entities in response to a condition change in at least one of the receiving entities;
distribute the indication of the second set of metrics to the receiving entities; and
receive metric data from the receiving entities based on the second set of one or more metrics.

8. The non-transitory computer readable storage medium of claim 7 further comprising instructions that, when executed by the one or more processors, cause the one or more processors to perform operational analysis on the received metric data corresponding to the first rule set to predict diminished performance of at least one of the receiving entities.

9. The non-transitory computer readable storage medium of claim 7, wherein the first rule set has a first set of reporting frequencies for metric data collected according to the first rule set and the second rule set has a second set of reporting frequencies for metric data collected according to the second rule set.

10. The non-transitory computer readable storage medium of claim 7, wherein the first rule set has a first set of collection frequencies for metric data collected according to the first rule set and the second rule set has a second set of collection frequencies for metric data collected according to the second rule set.

11. The non-transitory computer readable storage medium of claim 7, wherein first rule set results is collection of metric data from a first number of receiving entities and the second rule set results in collection of metric data from a second number of receiving entities.

12. A node in a distributed storage system comprising:
a memory system; and
one or more processors coupled with the memory system, the one or more processors to:
collect data according to a first rule set, wherein the rules in the first rule set indicate a first set of one or more metrics corresponding to operation of elements of the node,
transmit collected data corresponding to the first rule set to at least a management node in the distributed storage system, wherein the transmission frequency is determined by the first rule set,
receive a second rule set, wherein the rules in the second rule set indicate a first set of one or more metrics corresponding to operation of elements of the node,
collect data according to the second rule set, and
transmit collected data corresponding to the second rule set to the management node, wherein the transmission frequency is determined by the second rule set and is different than the transmission frequency for the first rule set.

13. The node of claim 12, wherein the first rule set has a first set of collection frequencies for metric data collected according to the first rule set and the second rule set has a second set of collection frequencies for metric data collected according to the second rule set.

14. The node of claim 12, wherein the one or more processors are further configured to monitor the node for a trigger condition indicating a change in operational conditions based on the metrics corresponding to the first rule set.

15. The node of claim 14, wherein the trigger condition indicating the change in operational conditions is evaluated using machine learning techniques.

16. The node of claim 14, wherein the one or more processors are further configured to transmit to the management node an indication of the trigger condition.

17. A non-transitory computer readable storage medium having stored thereon instructions that, when executed by one or more processors, cause the one or more processors to:
collect data according to a first rule set, wherein the rules in the first rule set indicate a first set of one or more metrics corresponding to operation of elements of the node,
transmit collected data corresponding to the first rule set to at least a management node in the distributed storage system, wherein the transmission frequency is determined by the first rule set,
receive a second rule set, wherein the rules in the second rule set indicate a first set of one or more metrics corresponding to operation of elements of the node,
collect data according to the second rule set, and
transmit collected data corresponding to the second rule set to the management node, wherein the transmission frequency is determined by the second rule set and is different than the transmission frequency for the first rule set.

18. The non-transitory computer readable storage medium of claim 17, wherein the first rule set has a first set of collection frequencies for metric data collected according to the first rule set and the second rule set has a second set of collection frequencies for metric data collected according to the second rule set.

19. The non-transitory computer readable storage medium of claim 17, wherein the instructions, when executed by the one or more processors, cause the one or more processors to monitor the node for a trigger condition indicating a change in operational conditions based on the metrics corresponding to the first rule set.

20. The non-transitory computer readable storage medium of claim 19, wherein the trigger condition indicating the change in operational conditions is evaluated using machine learning techniques.
